(19) United States
(12) Patent Application Publication
(10) Pub. No.: US 2017/0300249 A1
(43) Pub. Date: Oct. 19, 2017

(54) VALIDITY TRACKING FOR GARBAGE COLLECTION

(71) Applicant: Western Digital Technologies, Inc., Irvine, CA (US)

(72) Inventors: Adam Christopher Geml, Rochester, MN (US); Colin Christopher McCambridge, Rochester, MN (US); Philip James Sanders, Rochester, MN (US); Lee Anton Sendelbach, Rochester, MN (US)

(21) Appl. No.: 15/130,448

(22) Filed: Apr. 15, 2016

(51) Int. Cl. G06F 3/06; G06F 12/02

(52) U.S. Cl. CPC G06F 3/0619; G06F 12/0253; G06F 3/0679; G06F 3/0659; G06F 12/0246; G06F 2212/7205; G06F 2212/7209

(57) ABSTRACT

A storage device may include at least one memory device logically divided into a plurality of blocksets and a controller. The controller may be configured to receive a command to execute a garbage collection operation on a first blockset of the plurality of blocksets. The controller may be further configured to determine, based on a validity table stored in a non-volatile memory, whether data stored at a first block of the first blockset is valid, cause the data from the first block to be written to a second block of a second blockset of the plurality of blocksets, and modify the validity table to indicate that data stored in the first block is invalid and to indicate that data stored in the second block is valid.

### TECHNICAL FIELD

This disclosure relates to storage devices, such as solid state drives.

### BACKGROUND

Solid-state drives (SSDs) may be used in computers in applications where relatively low latency and high capacity storage are desired. In some examples, a controller of a storage device may reclaim invalid data stored by the storage device. For instance, where a blockset of memory stores valid data and invalid (e.g., stale) data, a controller may remove the invalid data by reading the valid data from the blockset, erasing the entire blockset, and writing the valid data back to the storage device at the same or a different physical location.

### SUMMARY

In some examples, a method includes receiving, by a controller of a storage device, a command to execute a garbage collection operation on a first blockset of the storage device, the first blockset including at least a first block associated with a first physical block address of the storage device. The method further includes determining, by the controller and based on a validity table stored in a non-volatile memory, whether data stored at the first block of the first blockset is valid in response to receiving the command to execute the garbage collection operation for the first blockset. The method further includes causing, by the controller, the data from the first block to be written to a second block of a second blockset of the storage device in response to determining that the data stored in the first block of the first blockset is valid. The method further includes modifying, by the controller, the validity table to indicate that data stored in the first block is invalid and to indicate that data stored in the second block is valid in response to causing the data from the first block to be written to the second block.

In some examples, a storage device includes at least one memory device logically divided into a plurality of blocksets and a controller. The controller is configured to receive a command to execute a garbage collection operation on a first blockset of the plurality of blocksets, the first blockset including at least a first block associated with a first physical block address of the storage device. In response to receiving the command to execute the garbage collection operation for the first blockset, the controller is further configured to determine, based on a validity table stored in a non-volatile memory, whether data stored at the first block of the first blockset is valid. In response to determining that the data stored in the first block of the first blockset is valid, the controller is further configured to cause the data from the first block to be written to a second block of a second blockset of the plurality of blocksets. In response to causing the data from the first block to be written to the second block, the controller is further configured to modify the validity table to indicate that data stored in the first block is invalid and to indicate that data stored in the second block is valid.

In some examples, a computer-readable storage medium including instructions that, when executed, configure one or more processors of a storage device to receive a command to execute a garbage collection operation on a first blockset of the storage device, the first blockset including at least a first block associated with a first physical block address of the storage device. In response to receiving the command to execute the garbage collection operation for the first blockset, the instructions further configure the one or more processors of a storage device to determine, based on a validity table stored in a non-volatile memory, whether data stored at the first block of the first blockset is valid, in response to determining that the data stored in the first block of the first blockset is valid, causing the data from the first block to be written to a second block of a second blockset of the storage device, and in response to causing the data from the first block to be written to the second block, modify the validity table to indicate that data stored in the first block is invalid and to indicate that data stored in the second block is valid.

In some examples, a system includes means for receive a command to execute a garbage collection operation on a first blockset of the storage device, the first blockset including at least a first block associated with a first physical block address of the storage device. The system further includes means for determining, based on a validity table stored in a non-volatile memory, whether data stored at the first block of the first blockset is valid. The system further includes means for causing the data from the first block to be written to a second block of a second blockset of the storage device in response to determining that the data stored in the first block of the first blockset is valid. The system further includes means for modifying the validity table to indicate that data stored in the first block is invalid and to indicate that data stored in the second block is valid in response to causing the data from the first block to be written to the second block.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic block diagram illustrating an example system including a storage device connected to a host device.

FIG. 2 is a conceptual block diagram illustrating an example memory device 12AA that includes multiple blocksets, each blockset including multiple blocks.

FIG. 3 is a conceptual and schematic block diagram illustrating an example controller.

FIG. 4 is an example plot illustrating a distribution of blocks and a corresponding validity table.

FIG. 5 is a flow diagram illustrating an example technique for performing a garbage collection operation for a blockset.

FIG. 6 is a flow diagram illustrating an example technique for performing a write operation.

### DETAILED DESCRIPTION

The disclosure describes techniques for validity tracking in a storage device, such as a solid state drive. In some examples, the validity tracking techniques may be utilized during garbage collection operations of the storage device. For example, a storage device (e.g., a NAND solid state drive) may include multiple blocksets. Additionally, each blockset may include multiple blocks, which each may include multiple data sectors. In some examples, a controller of the storage device may write data to a block only after erasing data previously stored in the block. Moreover, such storage devices may only permit erasing an entire blockset of blocks. In order to accommodate such small writing granularity and large erasing granularity, storage devices may use a garbage collection process that reclaims blocksets. More specifically, valid blocks of a blockset may be migrated to another blockset before erasing the blockset in order to prevent loss of data stored at the valid blocks. Once erased, the controller may use the blockset to store new data.

Some garbage collection processes may use an indirection system to track whether a block of a blockset contains valid data. For instance, data stored in a blockset may include a physical manifest listing logical block addresses for the blockset. An indirection system may include a logical to physical table mapping each logical block address to a physical block address for a block. Using the physical manifest and the logical to physical table, a controller may implement a garbage collection technique and determine whether a block contains valid data. More specifically, the controller may determine that a block at a particular physical block address is valid if the logical block address indicated in the physical manifest is mapped, by the logical to physical table, to the particular physical block address. However, validity tracking using the physical manifest may require both the physical manifest and the logical to physical table to enable correct garbage collection. Moreover, the physical manifest may be appended to include new logical block addresses without removing invalid logical block addresses. So, such garbage collection processes may be computationally inefficient since the controller may check each entry in the physical manifest even though most of the entries may be invalid. Due to such complexities, storage devices using an indirection system to track whether a block contains valid data may use complex firmware control algorithms that can be a substantial burden on general purpose processors of the storage device.

In accordance with techniques of this disclosure, a controller may implement a garbage collection technique that tracks whether a block of a blockset contains valid data using a validity table. For example, the validity table may indicate a validity of data stored by each physical block of the storage device. For instance, a logical ‘1’ may indicate that a corresponding block stores valid data and a logical ‘0’ may indicate that a corresponding block stores invalid data. In some examples, a controller of the storage device may update the validity table during write operations. For instance, in response receiving an instruction from a host instructing the storage device to write data associated with a logical block address to the storage device, the storage device may store the data to a block of the storage device and set a validity bit in the validity table that corresponds with the block to indicate valid data (e.g., a logical ‘1’). Then, in response to receiving updated data associated with the logical block address from the host device, the storage device may store the updated data to a new block, set a validity bit in the validity table that corresponds with the new block to indicate valid data (e.g., a logical ‘1’), and clear a validity bit in the validity table that corresponds with the old block to indicate invalid data (e.g., a logical ‘0’). Such processes may accommodate different indirection systems and physical manifests since the data validity process may be decoupled or separated from indirection systems and physical manifests. Moreover, garbage collection processes using a validity table may be a low burden on a general purpose processor of the storage device since a simple bit lookup may be used to determine whether data is valid, rather than a more complex algorithm utilizing an indirection table, physical manifest, or both. In some examples, garbage collection processes using a validity table may be implemented in hardware to even further reduce the burden on a general purpose processor of the storage device. For instance, in response to a hardware accelerator engine receiving, from the controller, a range of physical block addresses (e.g., a blockset), the hardware accelerator engine may output, to the controller, the physical block addresses within the range of physical block addresses that contain valid data.

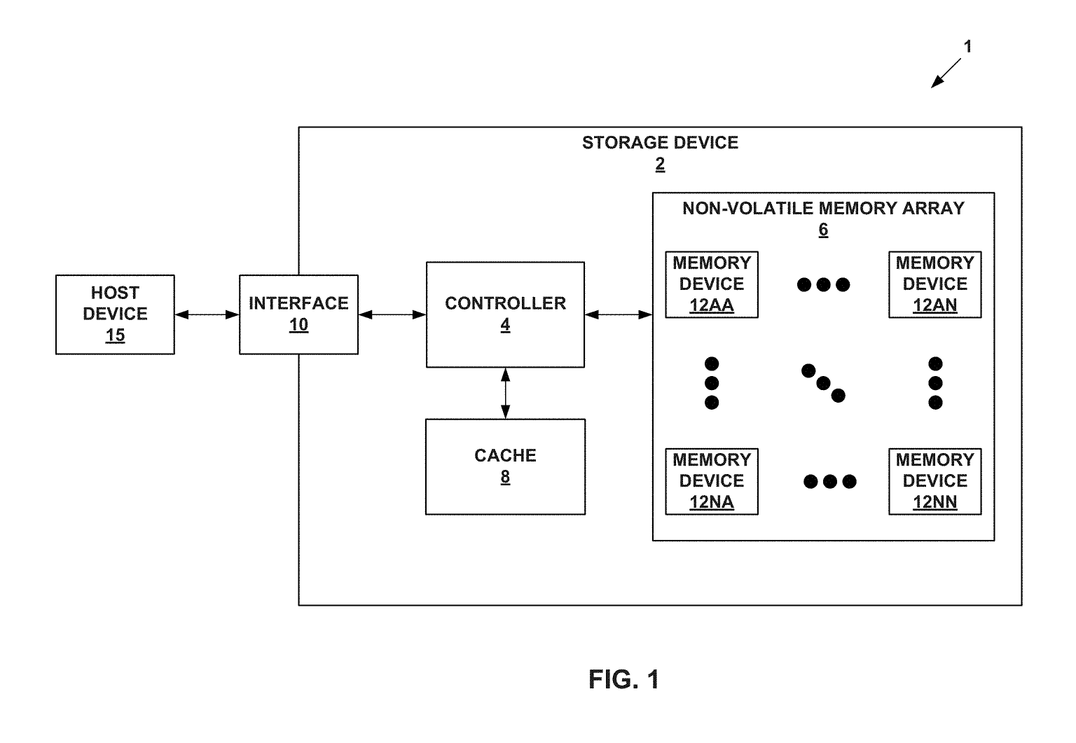

FIG. 1 is a conceptual and schematic block diagram illustrating an example system 1 including a storage device 2 connected to a host device 15. Host device 15 may utilize memory devices included in storage device 2 to store and retrieve data. As illustrated in FIG. 1, host device 15 may communicate with storage device 2 via interface 10. Host device 15 may include any computing device, including, for example, a computer server, a network attached storage (NAS) unit, a desktop computer, a notebook (e.g., laptop) computer, a tablet computer, a set-top box, a mobile computing device such as a “smart” phone, a television, a camera, a display device, a digital media player, a video gaming console, a video streaming device, or the like.

As illustrated in FIG. 1, storage device 2 may include controller 4, non-volatile memory array 6 (NVMA 6), cache 8, and interface 10. In some examples, storage device 2 may include additional components not shown in FIG. 1 for sake of clarity. For example, storage device 2 may include power delivery components, including, for example, a capacitor, super capacitor, or battery; a printed board (PB) to which components of storage device 2 are mechanically attached and which includes electrically conductive traces that electrically interconnect components of storage device 2; or the like.

In some examples, the physical dimensions and connector configurations of storage device 2 may conform to one or more standard form factors. Some example standard form factors include, but are not limited to, 3.5″ hard disk drive (HDD), 2.5″ HDD, 1.8″ HDD, peripheral component interconnect (PCI), PCI-extended (PCI-X), PCI Express (PCIe) (e.g., PCIe x1, x4, x8, x16, PCIe Mini Card, MiniPCI, etc.). In some examples, storage device 2 may be directly coupled (e.g., directly soldered) to a motherboard of host device 15.

Interface 10 may electronically connect storage device 2 with host device 15. For example, interface 10 may include one or both of a data bus for exchanging data with host device 15 and a control bus for exchanging commands with host device 15. Interface 10 may operate in accordance with any suitable protocol. For example, interface 10 may operate in accordance with one or more of the following protocols: advanced technology attachment (ATA) (e.g., serial-ATA (SATA), and parallel-ATA (PATA)), Fibre Channel, small computer system interface (SCSI), serially attached SCSI (SAS), peripheral component interconnect (PCI), PCI-express, and Non-Volatile Memory Express (NVMe). The electrical connection of interface 10 (e.g., the data bus, the control bus, or both) may be electrically connected to controller 4, providing electrical connection between host device 15 and controller, allowing data to be exchanged between host device 15 and controller 4. In some examples, the electrical connection of interface 10 may also permit storage device 2 to receive power from host device 15.

Storage device 2 includes controller 4, which may manage one or more operations of storage device 2. For instance, controller 4 may manage the reading of data from and/or the writing of data to memory devices 12AA-12NN (collectively, “memory devices 12”). In some examples, although not illustrated in FIG. 1, storage device 2 also may include a read channel, a write channel, or both, which may further manage one or more operations of storage device 2. For example, the read channel may, as one example, manage reads from memory devices 12, and the write channel may, as one example, manage writes to memory devices 12. In some examples, read channel may perform techniques of this disclosure, such as determining a values of respective bits stored by memory cells of memory devices 12.

NVMA 6 may include memory devices 12AA-12NN (collectively, “memory devices 12”) which may each be configured to store and/or retrieve data. For instance, a memory device of memory devices 12 may receive data and a message from controller 4 that instructs the memory device to store the data. Similarly, a memory device of memory devices 12 may receive a message from controller 4 that instructs the memory device to retrieve data. In some examples, each of memory devices 12 may be referred to as a die. In some examples, a single physical chip may include a plurality of dies (i.e., a plurality of memory devices 12). In some examples, each of memory devices 12 may be configured to store relatively large amounts of data (e.g., 256 MB, 512 MB, 1 GB, 2 GB, 4 GB, 8 GB, 16 GB, 32 GB, 64 GB, 128 GB, 256 GB, 512 GB, 1 TB, etc.).

In some examples, memory devices 12 may include any type of non-volatile memory devices. Some examples, of memory devices 12 include, but are not limited to flash memory devices, phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

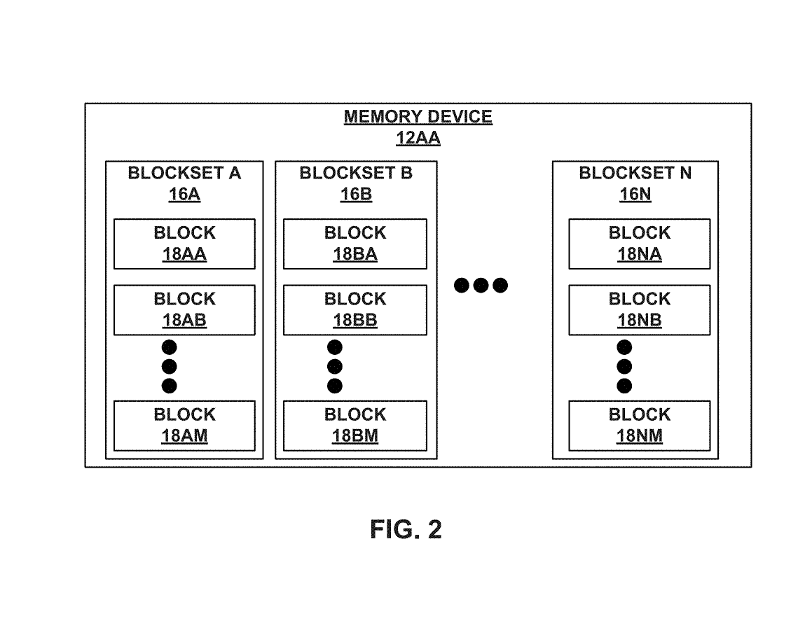

Flash memory devices may include NAND or NOR based flash memory devices, and may store data based on a charge contained in a floating gate of a transistor for each flash memory cell. In NAND flash memory devices, the flash memory device may be divided into a plurality of blocksets, each of which may be divided into a plurality of blocks (e.g., pages). FIG. 2 is a conceptual block diagram illustrating an example memory device 12AA, which includes blocksets 16A-16N (collectively, “blocksets 16”), each of which is divided into blocks 18AA-18NM (collectively, “blocks 18”). Each block of blocks 18 within a particular memory device (e.g., memory device 12AA) may include a plurality of flash memory cells. In NAND flash memory devices, rows of flash memory cells may be electrically connected using a word line to define a block of blocks 18. Respective cells in each of blocks 18 may be electrically connected to respective bit lines. Controller 4 may write data to and read data from NAND flash memory devices at the block level and erase data from NAND flash memory devices at the blockset level.

In some examples, it may not be practical for controller 4 to be separately connected to each memory device of memory devices 12. As such, the connections between memory devices 12 and controller 4 may be multiplexed. As an example, memory devices 12 may be grouped into channels. The memory devices 12 grouped into each of the channels may share one or more connections to controller 4. For instance, the memory devices 12 grouped into first channel may be attached to a common I/O bus and a common control bus. Storage device 2 may include a common I/O bus and a common control bus for each respective channel of the channels.

Storage device 2 also includes a cache 8, which may store data used by controller 4 used for controlling operation of storage device 2. Cache 8 may store information used by controller 4 for an indirection system to manage data stored in NVMA 6. For example, controller 4 may map, in a logical to physical table stored in cache 8, each logical block address of a set of logical block addresses with a corresponding physical block address for a block of NVMA 6. Cache 8 may store any suitable information for the indirection system, for instance, cache 8 may store information identifying namespaces of the NVMA 6. In some examples, information used for an indirection system may be stored in volatile memory. For instance, the logical to physical table may be stored in volatile memory of cache 8. In some examples, information used for an indirection system may be stored in non-volatile memory. For instance, the logical to physical table may be stored in non-volatile memory of cache 8. Cache 8 may include, for instance, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4)), and the like.

Controller 4 may manage one or more operations of storage device 2. Controller 4 may communicate with host device 15 via interface 10 and manage data stored in memory devices 12. For instance, in response to controller 4 receiving data and a logical block address from host device 15, controller 4 may cause NVMA 6 to write the data to a physical block address of memory device 12AA and map the physical block address to the logical block address in a logical to physical table stored in cache 8. Controller 4 may include a microprocessor, digital signal processor (DSP), application specific integrated circuit (ASIC), field programmable gate array (FPGA), or other digital logic circuitry.

In accordance with techniques of this disclosure, controller 4 may store a validity table (e.g., a physical validity table) in cache 8. Controller 4 may utilize the validity table when performing a garbage collection operation on NVMA 6. For instance, in response to controller 4 receiving, from host device 15, a command to execute a garbage collection operation on a blockset (e.g., block 16A of memory device 12AA of NVMA 6), controller 4 may determine whether each block (e.g., blocks 18AA-18AM) of the blockset is valid (i.e., stores valid data) based on the validity table rather than using an indirection system. More specifically, controller 4 may determine that a first block of the blockset is valid if the validity table stored in cache 8 includes an entry for the first block in which a bit is set. Then, controller 4 may cause the data from the first block to be written to a second block of another blockset of NVMA 6. For instance, controller 4 may instruct NVMA 6 to migrate data from the first block to the second block, and controller 4 may update a logical to physical table stored in cache 8 such that the logical block address previously mapped, by the logical to physical table, to the first block is mapped to the second block. Next, controller 4 may update the validity table of cache 8 to indicate that data stored in the first block is invalid and to indicate that data stored in the second block is valid. For instance, controller 4 may set the bit in the validity table that corresponds with the second block and clear the bit in the validity table that corresponds with the first block. Once all the valid data is migrated from the respective valid blocks in the particular blockset and each bit in the validity table that corresponds with the particular blockset is cleared, controller 4 may instruct NVMA 6 to erase the blockset. In this manner, controller 4 may reclaim a blockset without requiring forward searches in the indirection system to determine if data stored by blocks in the blockset is valid.

In some examples, cache 8 may include non-volatile memory, such that the validity table is maintained without provision of power to cache 8, allowing a validity of each block of storage device 2 to be determined after a reset of storage device 2. Such non-volatile memory may be any suitable medium with random byte-granularity read and write capacity. Examples of non-volatile memory may include, for example, phase change memory (PCM), static RAM (SRAM), magnetoresistive random-access memory (MRAIVI), or the like. In some examples, the validity table may be relatively small (e.g., 32 MB) such that fast and/or expensive memory may be used to store the validity table. For instance, using a single bit to indicate a validity of each 4 KB indirection unit (e.g., block) of a 1 TB storage device may use only 32 MB of cache 8. In some examples, cache 8 may include volatile memory, and data from cache 8 may be migrated to a persistent storage during a power loss event. For instance, controller 4 may move the validity table from volatile memory (e.g., DRAM) of cache 8 to non-volatile memory (e.g., NVMA 6, a non-volatile memory of cache 8, etc.) during a power loss event.

In accordance with techniques of this disclosure, controller 4 may implement a garbage collection technique that tracks whether a block of a blockset of NVMA 6 contains valid data using a validity table stored in cache 8 without complex algorithms utilizing an indirection table, a physical manifest, or both. For example, controller 4 may determine a validity of data stored by each physical block of NVMA 6 by simple bit lookups of the validity table stored in cache 8. Additionally, controller 4 may accommodate different indirection systems and physical manifests since the data validity process may be decoupled or separated from indirection systems and physical manifests.

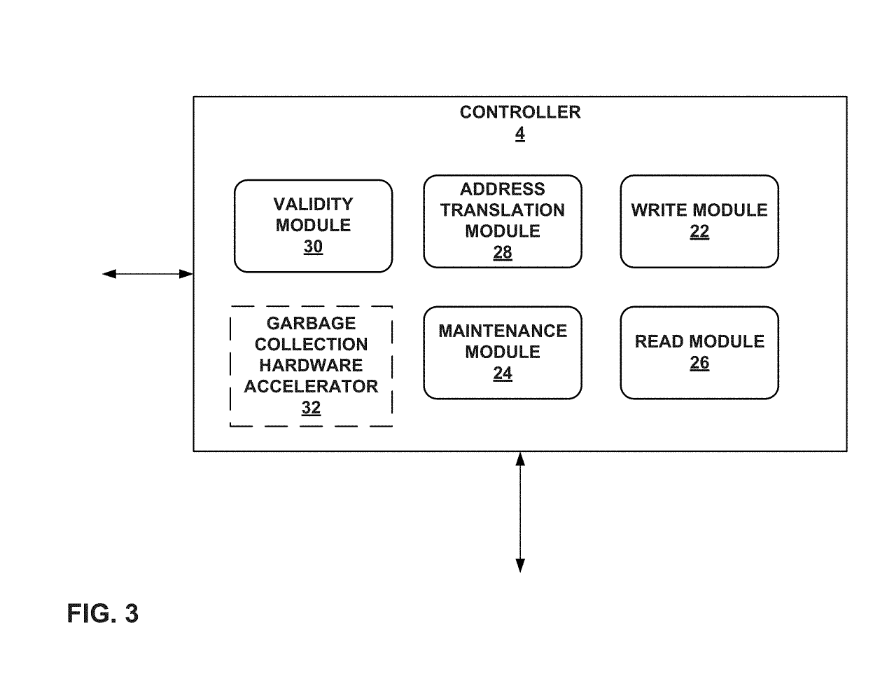

FIG. 3 is a conceptual and schematic block diagram illustrating an example controller 4. As illustrated, controller 4 may include write module 22, maintenance module 24, read module 26, address translation module 28, and validity module 30. In some examples, controller 4 may optionally include garbage collection hardware accelerator 32.

Address translation module 28 may associate a logical block address used by host device 15 with a physical block address of NVMA 6. For instance, in response to address translation module 28 receiving a logical block address from host device 15 as part of a read or write command, address translation module 28 may determine a physical block address of NVMA 6 that corresponds with the logical block address using an indirection system (e.g., a virtual or logical to physical table stored in cache 8).

Read module 26 may receive commands from host device 15 to retrieve data from NVMA 6. For instance, in response to read module 26 receiving, from host device 15, a command to read data at a logical block address, read module 26 may retrieve the data from NVMA 6.

Write module 22 may receive commands from host device 15 to write data to NVMA 6. For instance, in response to write module 22 receiving, from host device 15, a command to write data to a logical block address, write module 22 may write the data to an available block of NVMA 6 associated with a physical block address. In some examples, write module 22 may receive the physical block address associated with the available block of NVMA 6, for instance, but not limited to, from host device 15, from another module of controller 4 (such as address translation module 28), or the like. In some examples, write module 22 may determine the physical block address associated with the available block of NVMA 6.

Validity module 30 may determine whether data stored in NVMA 6 is valid or invalid using a validity table stored in cache 8. For instance, validity module 30 may set, in a validity table stored in cache 8, a validity value corresponding to a block that contains updated data and clear, in the validity table stored in cache 8, a validity value corresponding to a block that contains old data. Then, validity module 30 may determine whether a block contains valid data by a simple bit look up of the validity value. In some examples, validity module 30 may determine whether each block of a blockset contains valid data using the validity table stored in cache 8. In some examples, validity module 30 may determine that a block contains valid data when at least one data sector of the block contains valid data. In this manner, validity module 30 may reduce a computational burden on a processor of controller 4.

Maintenance module 24 may relocate valid data (e.g., not stale) to reclaim blocksets 16. For instance, in response to validity module 30 determining that only data sets 18AA and 18AM of blockset 16A contain valid data using a validity table stored in cache 8, maintenance module 24 may cause read module 26 and write module 22 to relocate the data stored in blocks 18AA and 18AM to permit blockset 16A to be reclaimed.

In instances where controller 4 includes garbage collection hardware accelerator 32, garbage collection hardware accelerator 32 may perform one or more garbage collection processes instead of a general purpose processor of controller 4 to reduce a computational burden on controller 4. For instance, garbage collection hardware accelerator 32 may determine whether data stored in a block is valid using a validity table stored in cache 8. Garbage collection hardware accelerator 32 may include a microprocessor, digital signal processor (DSP), application specific integrated circuit (ASIC), field programmable gate array (FPGA), or other digital logic circuitry.

In some instances, controller 4 may receive a command to execute a garbage collection operation on a blockset. For instance, host device 15 may send a command to storage device 2 that instructs storage device 2 to execute a garbage collection operation on blockset 16A of storage device 2. As another example, controller 4 may execute firmware that determines when to execute a garbage collection operation on a blockset.

In response to controller 4 receiving the command to execute the garbage collection operation, validity module 30 may determine whether data stored at a first block of the first blockset is valid. In some examples, validity module 30 may determine whether the data stored at the first block is valid based on a validity value indicating a valid value. For instance, in response to validity module 30 determining that a validity value mapped, by a validity table of cache 8, to a physical location associated with block 18AA of blockset 16A indicates a valid value (e.g., is set), validity module 30 may determine that the data stored at block 18AA is valid.

In response to validity module 30 determining that the data stored at the first block of the first blockset is valid, maintenance module 24 may cause the data from the first block of the first blockset to be written to a second block of a second blockset. For instance, in response to validity module 30 determining that block 18AA contains valid data, maintenance module 24 may relocate data stored at block 18AA of blockset 16A to block 18BA of blockset 16B. More specifically, maintenance module 24 may cause read module 26 to read data stored at block 18AA of blockset 16A and cause write module 22 to write the data read by read module 26 to block 18BA of blockset 16B.

In response to maintenance module 24 causing the data from the first block of the first blockset to be written to the second block of a second blockset, validity module 30 may modify the validity table stored in cache 8 to indicate that the data stored in the first block is invalid and to indicate that data stored in the second block is valid. For instance, validity module 30 may modify the validity table stored in cache 8 to indicate that the data stored in block 18AA is invalid and to indicate that data stored in block 18BA is valid. More specifically, validity module 30 may clear a validity value mapped, by the validity table stored in cache 8, to a physical block address associated with block 18AA and set a validity value mapped, by the validity table stored in cache 8, to a physical block address associated with block 18AB.

In some examples, maintenance module 24 may also update a logical to physical table to associate a logical block address with a block of NVMA 6. For instance, in response to maintenance module 24 causing the data from the first block of the first blockset to be written to the second block of a second blockset, maintenance module 24 may update a logical to physical table of cache 8 to associate a logical block address previously associated with the first block (e.g., block 18AA) with the second block (e.g., block 18BA). More specifically, maintenance module 24 may update the logical to physical table of cache 8 to map the logical block address to a physical block address associated with the second block (e.g., block 18BA). Although the above example illustrates a single valid block in a blockset, it should be understood that the above techniques may, in some examples, be similarly repeated for each block of the blockset. In this manner, the controller 4 may process the blockset such that all valid data is preserved.

In some examples, a method includes receiving, by controller 4 of storage device 2, a command to execute a garbage collection operation on blockset 16A of storage device 2, blockset 16A including at least block 18AA associated with a first physical block address of storage device 2. The method further includes, determining, by controller 4 and based on a validity table stored in cache 8, whether data stored at block 18AA of blockset 16A is valid in response to receiving the command to execute the garbage collection operation for the first blockset. The method further includes, causing, by controller 4, the data from the block 18AA to be written to block 18BA of blockset 16B of storage device 2 in response to determining that the data stored in block 18AA of blockset 16A is valid. The method further includes modifying, by controller 4, the validity table to indicate that data stored in block 18AA is invalid and to indicate that data stored in block 18BA is valid in response to causing the data from block 18AA to be written to block 18BA.

In instances where controller 4 includes garbage collection hardware accelerator 32, garbage collection hardware accelerator 32 may perform one or more garbage collection processes instead of a processor of controller 4 executing a module to reduce a computational burden on a general purpose processor of controller 4. For example, garbage collection hardware accelerator 32 may determine whether data stored in the first block is valid. For instance, garbage collection hardware accelerator 32 may lookup a validity value mapped, by a validity table of cache 8, to a physical location associated with block 18AA of blockset 16A. Then, in response to garbage collection hardware accelerator 32 determining that a validity value mapped, by a validity table of cache 8, to a physical location associated with block 18AA of blockset 16A indicates a valid value (e.g., is set), garbage collection hardware accelerator 32 may determine that the data stored at block 18AA is valid. Although the above example illustrates determining whether data stored in the first block is valid, it should be understood that the above techniques may, in some examples, be similarly repeated for each block of the blockset.

Garbage collection hardware accelerator 32 may output, to controller 4, a list of physical block addresses for garbage collection. For example, in response to garbage collection hardware accelerator 32 receiving, from controller 4, a range of physical block addresses, garbage collection hardware accelerator 32 may output, to controller 4, blocks within the range of physical block addresses that are valid. More specifically, garbage collection hardware accelerator 32 may determine that a block having physical block address within the range of physical block addressed provided from controller 4 is valid if the block is associated with a logical ‘1’ in the physical validity table stored in cache 8. Then, garbage collection hardware accelerator 32 may output, to controller 4, the list of all the physical block addresses of the range of physical block addresses that are associated with the logical ‘1’ in the physical validity table. In this manner, garbage collection hardware accelerator 32 may reduce a burden on a general purpose processor of controller 4.

In some examples, garbage collection hardware accelerator 32 may provide controller 4 with ready-to-write data and a list of corresponding logical block addresses. For example, garbage collection hardware accelerator 32 may cause NVMA 6 to read a physical manifest of a blockset and garbage collection hardware accelerator 32 may determine, using the physical manifest, a logical block address associated with a block of the blockset. Then, garbage collection hardware accelerator 32 may provide controller 4 (e.g., maintenance module 24) with a request to move the block to another physical block address and to update the logical to physical table of cache 8 with the logical block address determined from the physical manifest. In this manner, relocating data to reclaim a blockset may be substantially automated by garbage collection hardware accelerator 32, thereby further reducing a computational burden on a general processor of controller 4.

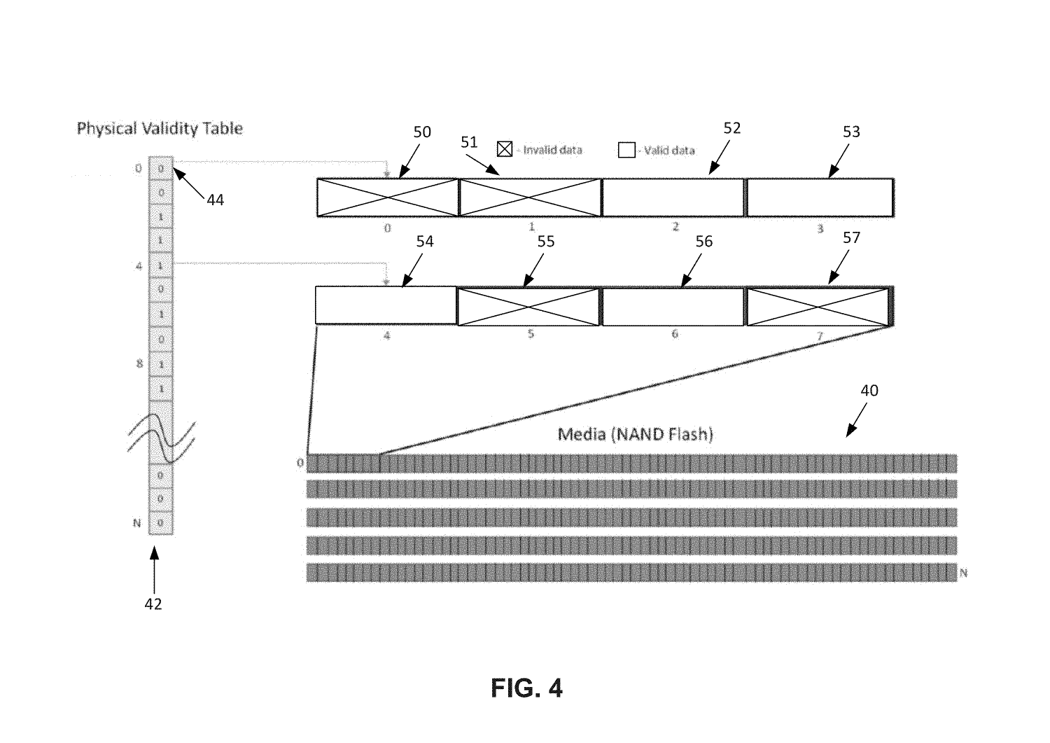

FIG. 4 is an example plot illustrating a distribution of blocks 40 and a corresponding validity table 42. In some examples, validity table 42 may include a validity value 44 that is a single bit. As shown, validity table 42 associates a clear bit (e.g., logical ‘0’) to block 50, block 51, block 55, and block 57. That is, block 50, block 51, block 55, and block 57 may contain invalid data (e.g., stale data). Examples of stale data may include instances where updated versions of the data are stored in other physical blocks. As shown, validity table 42 associates a set bit (e.g., logical ‘1’) to block 52, block 53, block 54, and block 56. That is, block 52, block 53, block 54, and block 56 may contain valid data. In this manner, validity module 30 and/or garbage collection hardware accelerator 32 may determine a validity of data stored in NVMA 6 using a simple bit lookup of validity table 42. As described above, in some examples a single bit may indicate a validity value (e.g., logical ‘1’ for valid, logical ‘0’ for invalid) for each block (e.g., blocks 40), which may permit validity table 42 to utilize relatively little memory space to permit use of fast memory (e.g., SRAM). Additionally, a controller (e.g., controller 4 of FIG. 3) may accommodate different indirection systems and physical manifests since the data validity process may use validity table 42 rather than information (e.g., a logical to physical table) associated with indirection systems and physical manifests. Moreover, garbage collection processes using validity table 42 may be a low burden on a general purpose processor of the storage device (e.g., storage device 2 of FIG. 1) since a simple bit lookup may be used to determine whether data is valid, rather than a more complex algorithm utilizing an indirection table, physical manifest, or both. Further, garbage collection processes using validity table 42 may be implemented in hardware (e.g., garbage collection hardware accelerator 32) to even further reduce a burden on a general purpose processor of the storage device (e.g., storage device 2 of FIG. 1).

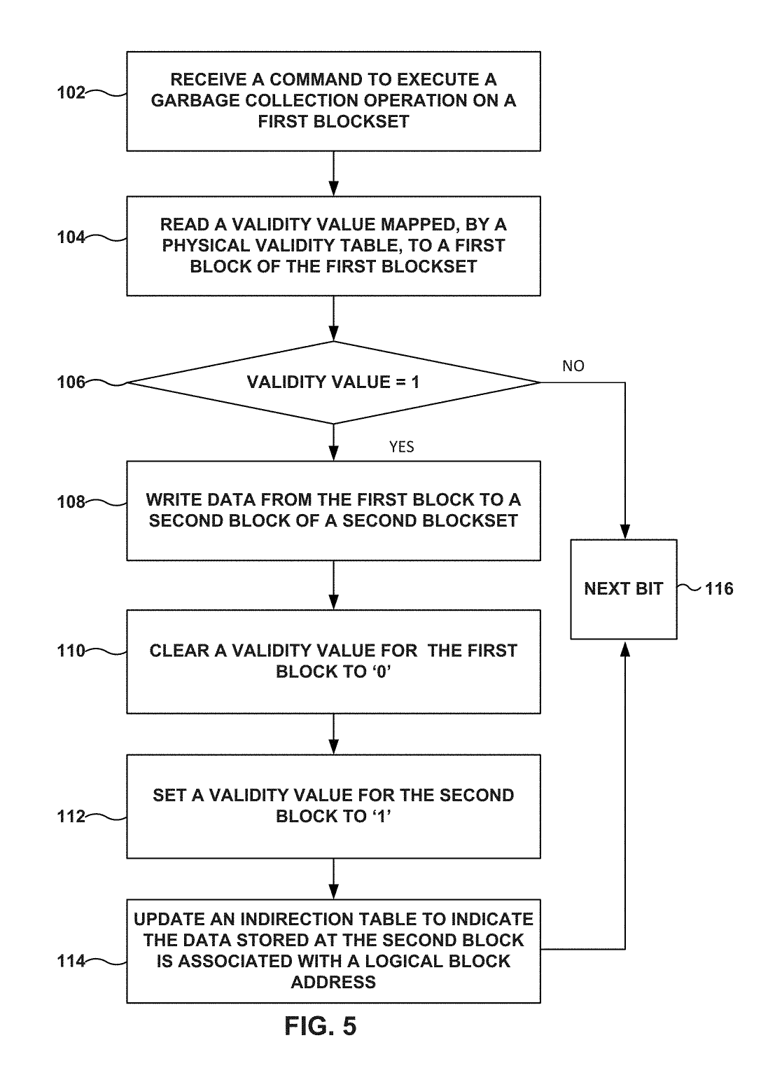

FIG. 5 is a flow diagram illustrating an example technique for performing a garbage collection operation for a blockset. The techniques of FIG. 5 will be described with concurrent reference to example system 1 of FIG. 1 and controller 4 of FIG. 3 for ease of description.

Storage device 2 may receive a command to execute a garbage collection operation on a first blockset (102). For instance, maintenance module 24 may receive, from host device 15, a command to execute a garbage collection operation on a first blockset. As another example, maintenance module 24 may determine to execute a garbage collection operation on a first blockset. Then, validity module 30 may read a validity value mapped, by a validity table, to a first block of the first blockset (104). For instance, validity module 30 may lookup a bit associated, by a validity table of cache 8, with a physical block address corresponding with the first block of the first blockset. Alternatively, garbage collection hardware accelerator 32 may read a validity value mapped, by a validity table, to a first block of the first blockset.

In instances where validity module 30 determines that the validity value indicates that data stored at the block is invalid (“NO” branch of 106), the process restarts for the next bit (116). For example, the process may be repeated for each block of the first blockset.

On the other hand, in instances where validity module 30 determines that the validity value indicates that data stored at the first block is valid (“YES” branch of 106), validity module 30 communicates an indication of the valid block to write module 22, and write module 22 writes data from the first block to a second block of a second blockset (108). For instance, write module 22 may receive, from maintenance module 24 or address translation module 28, a physical block address associated with a second block that is available (does not currently store data). Then, read module 26 retrieves the data stored at the first block and write module 22 writes the data to the second block.

Once write module 22 writes the data to the second block, validity module 30 clears a validity value for the first block to a logical ‘0’ (110). For instance, validity module 30 may clear a bit mapped, by the validity table stored in cache 8, to a first physical block address that is associated, by an indirection table stored in cache 8, with the first block. Additionally, validity module 30 sets a validity value for the second block to a logical ‘1’ (112). For instance, validity module 30 may set a bit mapped, by the validity table stored in cache 8, to a second physical block address that is associated, by an indirection table stored in cache 8, with the second block. In some examples, validity module 30 may clear the bit mapped to the first physical block address and simultaneously (e.g., in an atomic manner) set the bit mapped to the second physical block address.

In response to write module 22 writing the data to the second physical block address, maintenance module 24 also may update an indirection table to indicate the data stored at the second block is associated with a logical block address (114). For instance, maintenance module 24 may update a mapping, by an indirection table stored in cache 8, to associate a logical block address with the second physical block address that is associated with the second block instead of the first physical block address. In some examples, maintenance module 24 may update the indirection table simultaneously (e.g., in an atomic manner) with validity module 30 clearing the bit mapped to the first physical block address and/or setting the bit mapped to the second physical block address. Once the maintenance module 24 updates the logical to physical table, the process restarts for the next bit (116) until each valid block of the blockset is relocated to permit the blockset to be reclaimed.

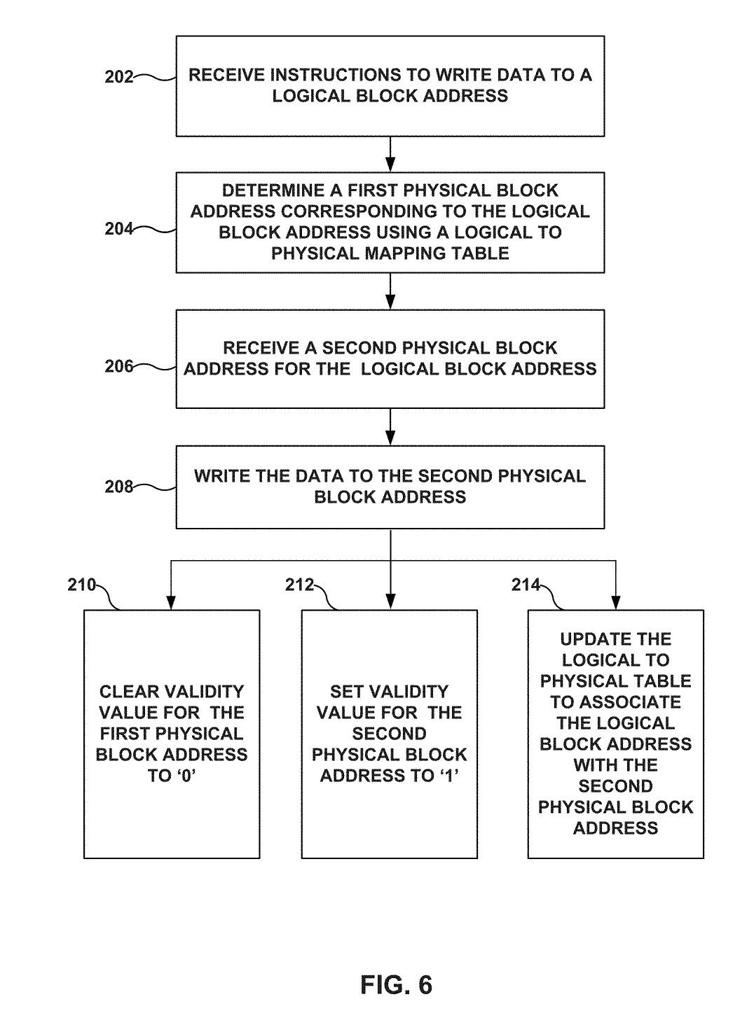

FIG. 6 is a flow diagram illustrating an example technique for performing a write operation. The techniques of FIG. 6 will be described with concurrent reference to example system 1 of FIG. 1 and controller 4 of FIG. 3 for ease of description.

Storage device 2 may receive instructions to write data to a logical block address (202). For instance, write module 22 may receive, from host device 15, instructions to write data to a logical block address. Then, address translation module 28 determines the first physical block address corresponding to the logical block address using a logical to physical table (204). For instance, address translation module 28 may determine the first physical block address by a lookup of the logical block address in a logical to physical table of cache 8. Then, write module 22 receives a second physical block address (206). For instance, host device 15 may output to write module 22 a list of available physical block addresses. In response to write module 22 receiving the second physical block address, write module 22 may write data from the first block to a second physical block address (208).

In response to the write module 22 writing the data to the second physical block address, validity module 30 may clear a validity value for the first physical block address to a logical ‘0’ (210). For instance, validity module 30 may clear a bit corresponding with the first physical block address. Additionally, validity module 30 may set a validity value for the second physical block address to a logical ‘1’ (212). For instance, validity module 30 may set a bit corresponding with the second physical block address. In some examples, validity module 30 may clear a validity value for the first physical block address to a logical ‘0’ and simultaneously (e.g., in an atomic manner) set a validity value for the second physical block address to a logical ‘1’.

In response to the write module 22 writing the data to the second physical block address, maintenance module 24 may update the logical to physical table to associate the logical block address with the second physical block address (214). For instance, maintenance module 24 may map the logical block address with the second physical block address. In some examples, maintenance module 24 may update the logical to physical table to associate the logical block address with the second physical block address simultaneously (e.g., in an atomic manner) with validity module 30 clearing a validity value for the first physical block address to a logical ‘0’ and/or setting a validity value for the second physical block address to a logical ‘1’.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
receiving, by a controller of a storage device, a command to execute a garbage collection operation on a first blockset of the storage device, the first blockset comprising at least a first block associated with a first physical block address of the storage device, and
in response to receiving the command to execute the garbage collection operation for the first blockset:
determining, by the controller and based on a validity table stored in a non-volatile memory, whether data stored at the first block of the first blockset is valid;
in response to determining that the data stored in the first block of the first blockset is valid, causing, by the controller, the data from the first block to be written to a second block of a second blockset of the storage device; and
in response to causing the data from the first block to be written to the second block, modifying, by the controller, the validity table to indicate that data stored in the first block is invalid and to indicate that data stored in the second block is valid.

2. The method of claim 1, wherein the controller comprises a hardware accelerator engine, and
wherein determining whether the data stored at the first block is valid comprises determining, by the hardware accelerator engine, whether the data stored at the first block is valid.

3. The method of claim 2, further comprising:
in response to determining that the data stored at the first block is valid, outputting, by the hardware accelerator engine, the first physical block address associated with the first block,
wherein writing the data is further in response to outputting the first physical block address associated with the first block.

4. The method of claim 2, further comprising:
in response to determining that the data stored at the first block is valid, causing, by the hardware accelerator engine, reading of the data at the first block; and
outputting, by the hardware accelerator engine and based on the data read from the first block, a logical block address associated with the first block.

5. The method of claim 4, further comprising:
in response to outputting the logical block address associated with the first block and causing the data from the first block to be written to the second block, updating, by the controller, an indirection table to indicate that the data associated with the logical block address is stored at the second block.

6. The method of claim 1, comprising:
wherein determining whether data stored at the first block of the first blockset is valid comprises:
determining, by the controller, a validity value mapped by the validity table to the first physical location associated with the first block; and
determining, by the controller, that the data stored at the first block is valid based on the validity value indicating a valid value.

7. The method of claim 1, comprising:
in response to receiving the command to execute the garbage collection operation for the first blockset, determining, by the controller and based on the validity table stored in the non-volatile memory, whether data stored at each block of the first blockset is valid.

8. A storage device comprising:
at least one memory device logically divided into a plurality of blocksets; and
a controller configured to:
receive a command to execute a garbage collection operation on a first blockset of the plurality of blocksets, the first blockset comprising at least a first block associated with a first physical block address of the storage device, and
in response to receiving the command to execute the garbage collection operation for the first blockset:
determine, based on a validity table stored in a non-volatile memory, whether data stored at the first block of the first blockset is valid;
in response to determining that the data stored in the first block of the first blockset is valid, cause the data from the first block to be written to a second block of a second blockset of the plurality of blocksets; and
in response to causing the data from the first block to be written to the second block, modify the validity table to indicate that data stored in the first block is invalid and to indicate that data stored in the second block is valid.

9. The storage device of claim 8, wherein the controller comprises a hardware accelerator engine, wherein the hardware accelerator engine is configured to:
determine whether the data stored at the first block is valid.

10. The storage device of claim 9, wherein the hardware accelerator engine is further configured to:
in response to determining that the data stored at the first block is valid, output the first physical block address associated with the first block,
wherein writing the data is further in response to outputting the first physical block address associated with the first block.

11. The storage device of claim 10, wherein the hardware accelerator engine is further configured to:
in response to determining that the data stored at the first block is valid, cause reading of the data at the first block; and
output, based on the data read from the first block, a logical block address associated with the first block.

12. The storage device of claim 11, wherein the controller is further configured to:
in response to outputting the logical block address associated with the first block and causing the data from the first block to be written to the second block, updating an indirection table to indicate that the data associated with the logical block address is stored at the second block.

13. The storage device of claim 8, wherein the controller is further configured to:
determine a validity value mapped by the validity table to the first physical location associated with the first block; and
determine that the data stored at the first block is valid based on the validity value indicating a valid value.

14. The storage device of claim 13, wherein the validity value is a single bit.

15. A computer-readable storage medium comprising instructions that, when executed, configure one or more processors of a storage device to:
receive a command to execute a garbage collection operation on a first blockset of the storage device, the first blockset comprising at least a first block associated with a first physical block address of the storage device, and
in response to receiving the command to execute the garbage collection operation for the first blockset:
determine, based on a validity table stored in a non-volatile memory, whether data stored at the first block of the first blockset is valid;
in response to determining that the data stored in the first block of the first blockset is valid, cause the data from the first block to be written to a second block of a second blockset of the storage device; and
in response to causing the data from the first block to be written to the second block, modify the validity table to indicate that data stored in the first block is invalid and to indicate that data stored in the second block is valid.

16. The computer-readable storage medium of claim 15, further comprising instructions that, when executed, configure one or more processors of the storage device to:
determine a validity value mapped by the validity table to the first physical location associated with the first block; and
determine that the data stored at the first block is valid based on the validity value indicating a valid value.

17. The computer-readable storage medium of claim 15, wherein the validity value is a single bit.

18. A system comprising:
means for receiving a command to execute a garbage collection operation on a first blockset of the storage device, the first blockset comprising at least a first block associated with a first physical block address of the storage device;
means for determining, based on a validity table stored in a non-volatile memory, whether data stored at the first block of the first blockset is valid;
means for causing the data from the first block to be written to a second block of a second blockset of the storage device in response to determining that the data stored in the first block of the first blockset is valid; and
means for modifying the validity table to indicate that data stored in the first block is invalid and to indicate that data stored in the second block is valid in response to causing the data from the first block to be written to the second block.

19. The system of claim 18, further comprising:
means for outputting the first physical block address associated with the first block in response to determining that the data stored at the first block is valid,
wherein writing the data is further in response to outputting the first physical block address associated with the first block.

20. The system of claim 18, further comprising:
means for reading of the data at the first block in response to determining that the data stored at the first block is valid; and
means for outputting, based on the data read from the first block, a logical block address associated with the first block.
